(19) United States
(12) Patent Application Publication
(10) Pub. No.: US 2019/0061472 A1
(43) Pub. Date: Feb. 28, 2019

(54) SOLENOID VALVE, REFRIGERATION DEVICE USING SAME, AND AIR CONDITIONING DEVICE FOR VEHICLES, USING SAME

(71) Applicant: SANDEN AUTOMOTIVE CLIMATE SYSTEMS CORPORATION, Isesaki-shi, Gunma (JP)

(72) Inventors: Megumi SHIGETA, Isesaki-shi, Gunma (JP); Fumiaki MIYAUCHI, Isesaki-shi, Gunma (JP); Tetsuya ISHIZEKI, Isesaki-shi, Gunma (JP)

(21) Appl. No.: 16/083,353

(22) PCT Filed: Feb. 24, 2017
(86) PCT No.: PCT/JP2017/008633

§ 371 Date: Sep. 7, 2018

(30) Foreign Application Priority Data
Mar. 9, 2016 (JP) 2016-045524

(51) Int. Cl. B60H 1/22; F16K 31/06; B60H 1/00; F25B 41/04; B60H 1/32

(52) U.S. Cl. CPC B60H 1/2218; F16K 31/0606; B60H 1/00278; F25B 41/062; F25B 41/046; B60H 1/323; B60H 1/00885

(57) ABSTRACT

There is disclosed a solenoid valve which is capable of effectively eliminating or inhibiting occurrence of an operational defect due to adhesion of a main valve body to a valve holder. A solenoid valve 40 includes a valve body 54 having a valve chamber 58, an inflow port 61, an outflow port 62, a valve seat 59 and a valve holder 72, a main valve body 67 movably disposed in the valve chamber, and a solenoid coil 51. Controlling of energization to the solenoid coil provides a state where the main valve body is in contact with the valve seat to cut off communication between the inflow port and the outflow port and a state where the main valve body is in contact with the valve holder to provide the communication between the inflow port and the outflow port. A removed portion is formed on an inner side of an end face of the main valve body 67 which is in contact with the valve holder 72, and a relation of Sd>SD×0.7 is satisfied.

### CROSS-REFERENCE TO RELATED APPLICATIONS

This application is a U.S. National Stage Patent Application under 37 U.S.C. § 371 of International Patent Application No. PCT/JP2017/008633, filed on Feb. 24, 2017, which claims the benefit of Japanese Patent Application No. JP 2016-045524, filed on Mar. 9, 2016, the disclosures of which are incorporated herein by reference in their entirety.

### TECHNICAL FIELD

The present invention relates to a solenoid valve having a constitution in which energization to a solenoid coil is controlled to bring a main valve body into contact with or away from a valve seat, thereby cutting off or providing communication between an inflow port and an outflow port, a refrigeration device using the same, and an air conditioning device for vehicles, using the same.

### BACKGROUND ART

Heretofore, this type of solenoid valve has a constitution in which a main valve body is movably disposed in a valve chamber, and by energization and non-energization to a solenoid coil, this main valve body is moved to a state where the main valve body is in contact with a valve seat to cut off communication between an inflow port and an outflow port, and the main valve body is moved away from the valve seat to change to a state where the main valve body is in contact with the valve holder to provide the communication between the inflow port and the outflow port (e.g., see Patent Document 1).

### CITATION LIST

### Patent Documents

Patent Document 1: Japanese Patent Application Publication No. H10-196838

### SUMMARY OF THE INVENTION

### Problems to be Solved by the Invention

However, when such a solenoid valve is used in a refrigeration device including a refrigerant circuit, oil to circulate together with a refrigerant through a compressor circulates in the circuit. Furthermore, when viscosity of this oil is high, there is the problem that a main valve body adheres to a valve holder, thereby causing an operational defect.

The present invention has been developed to solve such a conventional technical problem, and an object thereof is to provide a solenoid valve which is capable of effectively eliminating or inhibiting occurrence of an operational defect due to adhesion of a main valve body to a valve holder, a refrigeration device using the solenoid valve, or an air conditioning device for vehicles, using the refrigeration device.

### Means for Solving the Problems

A solenoid valve of the invention of claim 1 includes a valve body having a valve chamber, an inflow port, an outflow port, a valve seat and a valve holder, a main valve body movably disposed in the valve chamber, and a solenoid coil, so that controlling of energization to this solenoid coil provides a state where the main valve body is in contact with the valve seat to cut off communication between the inflow port and the outflow port and a state where the main valve body is in contact with the valve holder to provide the communication between the inflow port and the outflow port, and the solenoid valve is characterized in that a removed portion formed by cutting an inner side of an end face of the main valve body which is in contact with the valve holder is disposed, and a relation of Sd>SD×0.7 is satisfied, in which Sd is an area of a circle having an inner diameter ϕd, SD is an area of a circle having an outer diameter ϕD, ϕd is the inner diameter, and ϕD is the outer diameter of the end face of the main valve body.

The solenoid valve of the invention of claim 2 is characterized in that in the above invention, the removed portion is cut obliquely away from the valve holder toward its inner side.

A solenoid valve of the invention of claim 3 includes a valve body having a valve chamber, an inflow port, an outflow port, a valve seat and a valve holder, a main valve body movably disposed in the valve chamber, and a solenoid coil, so that controlling of energization to this solenoid coil provides a state where the main valve body is in contact with the valve seat to cut off communication between the inflow port and the outflow port and a state where the main valve body is in contact with the valve holder to provide the communication between the inflow port and the outflow port, and the solenoid valve is characterized in that in an end face of the main valve body on the side of the valve holder, an abutment portion which abuts on the valve holder and a non-abutment portion which does not abut on the valve holder are formed.

A solenoid valve of the invention of claim 4 includes a valve body having a valve chamber, an inflow port, an outflow port, a valve seat and a valve holder, a main valve body movably disposed in the valve chamber, and a solenoid coil, so that controlling of energization to this solenoid coil provides a state where the main valve body is in contact with the valve seat to cut off communication between the inflow port and the outflow port and a state where the main valve body is in contact with the valve holder to provide the communication between the inflow port and the outflow port, and the solenoid valve is characterized in that an abutment portion which abuts on the main valve body and a non-abutment portion which does not abut on the main valve body are formed in the valve holder.

The solenoid valve of the invention of claim 5 is characterized in that in claim 3 or claim 4, the valve holder and end face of the main valve body on the valve holder side possess an annular shape, and the non-abutment portion is formed in an annular shape along an arc of the valve holder or the end face of the main valve body.

The solenoid valve of the invention of claim 6 is characterized in that in claim 3 or claim 4, the valve holder and end face of the main valve body on the valve holder side possess an annular shape, and the non-abutment portions are formed radially from the center of an arc of the valve holder or the end face of the main valve body.

A refrigeration device of the invention of claim 7 includes a refrigerant circuit having the solenoid valve according to any one of claim 1 to claim 6, and this refrigerant circuit is filled with refrigerant and oil.

An air conditioning device for vehicles of the invention of claim 8 includes a compressor to compress a refrigerant, an air flow passage through which air to be supplied to a vehicle interior flows, a radiator to let the refrigerant radiate heat, thereby heating the air to be supplied from the air flow passage to the vehicle interior, a heat absorber to let the refrigerant absorb heat, thereby cooling the air to be supplied from the air flow passage to the vehicle interior, an outdoor heat exchanger disposed outside the vehicle interior, an outdoor expansion valve to decompress the refrigerant flowing into this outdoor heat exchanger, and a plurality of solenoid valves to change flow of the refrigerant, and the air conditioning device is characterized in that as these solenoid valves, the solenoid valves according to any one of claim 1 to claim 6 are used, and the solenoid valves are controlled to switch among and execute a plurality of operation modes.

### Advantageous Effect of the Invention

According to the invention of claim 1, a solenoid valve includes a valve body having a valve chamber, an inflow port, an outflow port, a valve seat and a valve holder, a main valve body movably disposed in the valve chamber, and a solenoid coil, so that controlling of energization to this solenoid coil provides a state where the main valve body is in contact with the valve seat to cut off communication between the inflow port and the outflow port and a state where the main valve body is in contact with the valve holder to provide the communication between the inflow port and the outflow port, and the solenoid valve is characterized in that a removed portion formed by cutting an inner side of an end face of the main valve body which is in contact with the valve holder is disposed, and a relation of Sd>SD×0.7 is satisfied, in which Sd is an area of a circle having an inner diameter ϕd, SD is an area of a circle having an outer diameter ϕD, ϕd is the inner diameter, and ϕD is the outer diameter of the end face of the main valve body. Consequently, a contact area between the main valve body and the valve holder decreases, and it is possible to effectively inhibit or eliminate adhesion of both the components due to oil.

In particular, the inner side of the end face of the main valve body which is in contact with the valve holder is cut to constitute the removed portion, and hence any hindrance does not occur in movement of the main valve body. Consequently, the main valve body easily separates from the valve holder, an operational defect is hard to occur, and the solenoid valve is remarkably effective for use in a refrigeration device as in the invention of claim 7 and an air conditioning device for vehicles as in the invention of claim 8.

In this case, as in the invention of claim 2, the removed portion is cut obliquely away from the valve holder toward its inner side, and according to this constitution, it is possible to maintain strength of the end face of the main valve body which abuts on the valve holder.

Furthermore, according to the invention of claim 3, a solenoid valve includes a valve body having a valve chamber, an inflow port, an outflow port, a valve seat and a valve holder, a main valve body movably disposed in the valve chamber, and a solenoid coil, so that controlling of energization to this solenoid coil provides a state where the main valve body is in contact with the valve seat to cut off communication between the inflow port and the outflow port and a state where the main valve body is in contact with the valve holder to provide the communication between the inflow port and the outflow port, and in the solenoid valve, in an end face of the main valve body on the side of the valve holder, an abutment portion which abuts on the valve holder and a non-abutment portion which does not abut on the valve holder are formed. Consequently, a contact area between the main valve body and the valve holder decreases, and it is possible to effectively inhibit or eliminate adhesion of both the components due to oil. In consequence, the main valve body easily separates from the valve holder, the operational defect is hard to occur, and the solenoid valve is remarkably effective for use in the refrigeration device as in the invention of claim 7 or the air conditioning device for vehicles as in the invention of claim 8.

Additionally, according to the invention of claim 4, a solenoid valve includes a valve body having a valve chamber, an inflow port, an outflow port, a valve seat and a valve holder, a main valve body movably disposed in the valve chamber, and a solenoid coil, so that controlling of energization to this solenoid coil provides a state where the main valve body is in contact with the valve seat to cut off communication between the inflow port and the outflow port and a state where the main valve body is in contact with the valve holder to provide the communication between the inflow port and the outflow port, and an abutment portion which abuts on the main valve body and a non-abutment portion which does not abut on the main valve body are formed in the valve holder. Consequently, a contact area between the valve holder and the main valve body decreases, and it is possible to effectively inhibit or eliminate the adhesion of both the components due to oil. In consequence, the main valve body easily separates from the valve holder, the operational defect is hard to occur, and the solenoid valve is remarkably effective for use in the refrigeration device as in the invention of claim 7 or the air conditioning device for vehicles as in the invention of claim 8.

In these cases, the valve holder and end face of the main valve body on the valve holder side possess an annular shape, and as in the invention of claim 5, the non-abutment portion may be formed in an annular shape along an arc of the valve holder or the end face of the main valve body, and as in the invention of claim 6, the non-abutment portions may be formed radially from the center of the arc of the valve holder or the end face of the main valve body.

### BRIEF DESCRIPTION OF THE DRAWINGS

FIG. 1 is a constitutional view of an air conditioning device for vehicles of an embodiment to which the present invention is applied;

FIG. 2 is a cross-sectional view of a solenoid valve connected to a refrigerant circuit of the air conditioning device for the vehicles of FIG. 1;

FIG. 3 is a view to explain a shape of an end face of a main valve body of the solenoid valve of FIG. 2 on the side of a valve holder (Embodiment 1);

FIG. 4 is a view to explain an operation of the solenoid valve of FIG. 2;

FIG. 5 is similarly a view to explain the operation of the solenoid valve of FIG. 2;

FIG. 6 is similarly a view to explain the operation of the solenoid valve of FIG. 2;

FIG. 7 is a view to explain another shape of the end face of the main valve body of the solenoid valve of FIG. 2 on the valve holder side (Embodiment 2);

FIG. 8 is an enlarged cross-sectional view of a portion of the main valve body of the solenoid valve of FIG. 7 on the valve holder side;

FIG. 9 is a view to explain still another shape of the end face of the main valve body of the solenoid valve of FIG. 2 on the valve holder side (Embodiment 3);

FIG. 10 is a view to explain a further shape of the end face of the main valve body of the solenoid valve of FIG. 2 on the valve holder side (Embodiment 4); and

FIG. 11 is a view to explain a shape of an end face of a main valve body of a conventional solenoid valve on the side of a valve holder.

### MODE FOR CARRYING OUT THE INVENTION

Hereinafter, description will be made as to embodiments of the present invention in detail with reference to the drawings.

### Embodiment 1

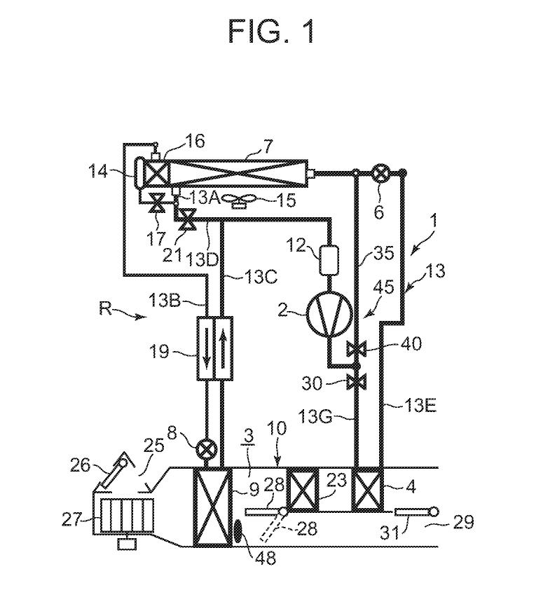

FIG. 1 shows a constitutional view of an air conditioning device for vehicles 1 of an embodiment of a refrigeration device to which the present invention is applied. A vehicle of the embodiment to which the air conditioning device for the vehicles 1 of FIG. 1 is applied is an electric vehicle (EV) in which an engine (an internal combustion engine) is not mounted, and runs with an electric motor for running which is driven by power charged in a battery (which is not shown in the drawing), and the air conditioning device for the vehicles 1 is also driven by the power of the battery. That is, in the electric vehicle which is not capable of performing heating by engine waste heat, the air conditioning device for the vehicles 1 of the embodiment performs a heating mode by a heat pump operation in which a refrigerant circuit is used, and furthermore, the device selectively executes respective operation modes of a dehumidifying and heating mode, a dehumidifying and cooling mode, a cooling mode, and a MAX cooling mode as the maximum cooling mode.

It is to be noted that the vehicle is not limited to the electric vehicle, and the present invention is also effective for a so-called hybrid car in which the engine is used together with the electric motor for running. Furthermore, needless to say, the present invention is also applicable to a usual car which runs with the engine.

The air conditioning device for the vehicles 1 of the embodiment performs air conditioning (heating, cooling, dehumidifying, and ventilation) of a vehicle interior of the electric vehicle, and there are successively connected, by a refrigerant pipe 13, an electric type of compressor 2 to compress a refrigerant, a radiator 4 disposed in an air flow passage 3 of an HVAC unit 10 in which vehicle interior air passes and circulates, to let the high-temperature high-pressure refrigerant discharged from the compressor 2 and flowing inside via a refrigerant pipe 13G radiate heat in the vehicle interior, an outdoor expansion valve 6 constituted of an electric valve which decompresses and expands the refrigerant during the heating, an outdoor heat exchanger 7 which is disposed outside the vehicle interior to perform heat exchange between the refrigerant and outdoor air, thereby functioning as the radiator during the cooling and functioning as an evaporator during the heating, an indoor expansion valve 8 constituted of an electric valve to decompress and expand the refrigerant, a heat absorber 9 disposed in the air flow passage 3 to let the refrigerant absorb heat from interior and exterior of the vehicle during the cooling and during the dehumidifying, an accumulator 12, and others, thereby constituting a refrigerant circuit R.

Furthermore, this refrigerant circuit R is charged with a predetermined amount of refrigerant and a predetermined amount of lubricating oil. It is to be noted that an outdoor blower 15 is provided in the outdoor heat exchanger 7. The outdoor blower 15 forcibly sends the outdoor air through the outdoor heat exchanger 7 to perform the heat exchange between the outdoor air and the refrigerant, whereby the outdoor air passes through the outdoor heat exchanger 7 also during stopping of the vehicle (i.e., a velocity is 0 km/h).

Furthermore, the outdoor heat exchanger 7 has a receiver drier portion 14 and a subcooling portion 16 successively on a refrigerant downstream side, a refrigerant pipe 13A extending out from the outdoor heat exchanger 7 is connected to the receiver drier portion 14 via a solenoid valve 17 for cooling which is to be opened in the dehumidifying and heating mode, the dehumidifying and cooling mode, the cooling mode and the MAX cooling mode, and a refrigerant pipe 13B on an outlet side of the subcooling portion 16 is connected to an inlet side of the heat absorber 9 via the indoor expansion valve 8. It is to be noted that the receiver drier portion 14 and the subcooling portion 16 structurally constitute a part of the outdoor heat exchanger 7.

Additionally, the refrigerant pipe 13B between the subcooling portion 16 and the indoor expansion valve 8 is disposed in a heat exchange relation with a refrigerant pipe 13C positioned on an outlet side of the heat absorber 9, and both the pipes constitute an internal heat exchanger 19. In consequence, the refrigerant flowing into the indoor expansion valve 8 through the refrigerant pipe 13B is cooled (subcooled) by the low-temperature refrigerant flowing out from the heat absorber 9.

In addition, the refrigerant pipe 13A extending out from the outdoor heat exchanger 7 branches to a refrigerant pipe 13D, and this branching refrigerant pipe 13D communicates and connects with the refrigerant pipe 13C on a downstream side of the internal heat exchanger 19 via a solenoid valve 21 for heating which is to be opened in the heating mode. The refrigerant pipe 13C is connected to the accumulator 12 and the accumulator 12 is connected to a refrigerant suction side of the compressor 2. Furthermore, a refrigerant pipe 13E on an outlet side of the radiator 4 is connected to an inlet side of the outdoor heat exchanger 7 via the outdoor expansion valve 6.

Furthermore, in the refrigerant pipe 13G between a discharge side of the compressor 2 and an inlet side of the radiator 4, a solenoid valve 30 for reheating is interposed which is to be opened in the heating mode, the dehumidifying and cooling mode and the cooling mode and is to be closed in the dehumidifying and heating mode and the MAX cooling mode. In this case, the refrigerant pipe 13G branches to a bypass pipe 35 on an upstream side of the solenoid valve 30, and the bypass pipe 35 communicates and connects with the refrigerant pipe 13E on a downstream side of the outdoor expansion valve 6 via a solenoid valve 40 for bypass which is to be opened in the dehumidifying and heating mode and the MAX cooling mode and to be closed in the heating mode, the dehumidifying and cooling mode and the cooling mode. The bypass pipe 35, the solenoid valve 30 and the solenoid valve 40 constitute a bypass device 45.

Thus, the bypass pipe 35, the solenoid valve 30 and the solenoid valve 40 constitute the bypass device 45, so that it is possible to smoothly switch among the dehumidifying and heating mode or the MAX cooling mode in which the refrigerant discharged from the compressor 2 directly flows into the outdoor heat exchanger 7 as described later, and the heating mode, the dehumidifying and cooling mode and the cooling mode in which the refrigerant discharged from the compressor 2 flows into the radiator 4.

Additionally, in the air flow passage 3 on an air upstream side of the heat absorber 9, respective suction ports such as an outdoor air suction port and an indoor air suction port are formed (represented by a suction port 25 in FIG. 1), and in the suction port 25, a suction changing damper 26 is disposed to change the air to be introduced into the air flow passage 3 to indoor air which is air of the vehicle interior (an indoor air circulating mode) and outdoor air which is air outside the vehicle interior (an outdoor air introducing mode). Furthermore, on an air downstream side of the suction changing damper 26, an indoor blower (a blower fan) 27 is disposed to supply the introduced indoor or outdoor air to the air flow passage 3.

Furthermore, in FIG. 1, 23 denotes an auxiliary heater as an auxiliary heating device disposed in the air conditioning device for the vehicles 1 of the embodiment. The auxiliary heater 23 of the embodiment is constituted of a PTC heater which is an electric heater, and disposed in the air flow passage 3 on an air upstream side of the radiator 4 to the flow of the air in the air flow passage 3. Then, when the auxiliary heater 23 is energized to generate heat, the air in the air flow passage 3 which flows through the heat absorber 9 into the radiator 4 is heated. That is, the auxiliary heater 23 becomes a so-called heater core to perform the heating of the vehicle interior or complement the heating.

Additionally, in the air flow passage 3 on an air upstream side of the auxiliary heater 23, an air mix damper 28 is disposed to adjust a ratio at which the air in the air flow passage 3 (the indoor or outdoor air) flowing into the air flow passage 3 and passed through the heat absorber 9 is to be passed through the auxiliary heater 23 and the radiator 4. Furthermore, in the air flow passage 3 on an air downstream side of the radiator 4, there is formed each outlet (represented by an outlet 29 in FIG. 1) of foot, vent or defroster, and in the outlet 29, an outlet changing damper 31 is disposed to execute changing control of blowing of the air from each outlet mentioned above.

Next, an operation of the air conditioning device for the vehicles 1 of the embodiment having the above constitution will be described. In the embodiment, the respective operation modes of the heating mode, the dehumidifying and heating mode, the dehumidifying and cooling mode, the cooling mode and the MAX cooling mode are switched and executed.

(1) Heating Mode

When the heating mode is selected in an automatic mode or by a manual operation, the solenoid valve 21 (for the heating) is opened and the solenoid valve 17 (for the cooling) is closed. Furthermore, the solenoid valve 30 (for the reheating) is opened and the solenoid valve 40 (for the bypass) is closed.

Then, the compressor 2 and the respective blowers 15 and 27 are operated, and the air mix damper 28 has a state of sending, through the auxiliary heater 23 and the radiator 4, all the air in the air flow passage 3 that is blown out from the indoor blower 27 through the heat absorber 9 as shown by a broken line in FIG. 1. In consequence, a high-temperature high-pressure gas refrigerant discharged from the compressor 2 flows through the solenoid valve 30 and flows from the refrigerant pipe 13G into the radiator 4. The air in the air flow passage 3 passes through the radiator 4, and hence the air in the air flow passage 3 heats by the high-temperature refrigerant in the radiator 4 (by the auxiliary heater 23 and the radiator 4 when the auxiliary heater 23 operates), while the refrigerant in the radiator 4 has the heat taken by the air and is cooled to condense and liquefy.

The refrigerant liquefied in the radiator 4 flows out from the radiator 4 and then flows through the refrigerant pipe 13E to reach the outdoor expansion valve 6. The refrigerant flowing into the outdoor expansion valve 6 is decompressed therein, and then flows into the outdoor heat exchanger 7. The refrigerant flowing into the outdoor heat exchanger 7 evaporates, and the heat is pumped up from the outdoor air passed by running or the outdoor blower 15. In other words, the refrigerant circuit R functions as a heat pump. Then, the low-temperature refrigerant flowing out from the outdoor heat exchanger 7 flows through the refrigerant pipe 13A, the solenoid valve 21 and the refrigerant pipe 13D, and flows from the refrigerant pipe 13C into the accumulator 12 to perform gas-liquid separation, and the gas refrigerant is sucked into the compressor 2, thereby repeating this circulation. The air heated in the radiator 4 (in the auxiliary heater 23 and the radiator 4 when the auxiliary heater 23 operates) is blown out from the outlet 29, thereby performing the heating of the vehicle interior.

(2) Dehumidifying and Heating Mode

Next, in the dehumidifying and heating mode, the solenoid valve 17 is opened and the solenoid valve 21 is closed. Furthermore, the solenoid valve 30 is closed, the solenoid valve 40 is opened, and a valve position of the outdoor expansion valve 6 is adjusted to a shutoff position. Then, the compressor 2 and the respective blowers 15 and 27 are operated, and as shown by the broken line in FIG. 1, the air mix damper 28 has the state of sending, through the auxiliary heater 23 and the radiator 4, all the air in the air flow passage 3 that is blown out from the indoor blower 27 through the heat absorber 9.

In consequence, the high-temperature high-pressure gas refrigerant discharged from the compressor 2 to the refrigerant pipe 13G flows into the bypass pipe 35 without flowing toward the radiator 4, and flows through the solenoid valve 40 to reach the refrigerant pipe 13E on the downstream side of the outdoor expansion valve 6. At this time, the outdoor expansion valve 6 is shut off, and hence the refrigerant flows into the outdoor heat exchanger 7. The refrigerant flowing into the outdoor heat exchanger 7 is cooled by running therein or the outdoor air passed through the outdoor blower 15, to condense. The refrigerant flowing out from the outdoor heat exchanger 7 flows from the refrigerant pipe 13A through the solenoid valve 17 successively into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and flows through the internal heat exchanger 19 to reach the indoor expansion valve 8. In the indoor expansion valve 8, the refrigerant is decompressed, and then flows into the heat absorber 9 to evaporate. By a heat absorbing operation at this time, the air blown out from the indoor blower 27 is cooled, and water in the air coagulates to adhere to the heat absorber 9. Therefore, the air in the air flow passage 3 is cooled and dehumidified. The refrigerant evaporated in the heat absorber 9 flows through the internal heat exchanger 19 and the refrigerant pipe 13C to reach the accumulator 12, and flows therethrough to be sucked into the compressor 2, thereby repeating the circulation.

At this time, the valve position of the outdoor expansion valve 6 is adjusted to the shutoff position, so that it is possible to inhibit or prevent the disadvantage that the refrigerant discharged from the compressor 2 flows from the outdoor expansion valve 6 back into the radiator 4. Consequently, it is possible to inhibit or eliminate decrease of an amount of the refrigerant to be circulated, thereby acquiring the air conditioning capability. Furthermore, in this dehumidifying and heating mode, the auxiliary heater 23 is energized to generate heat. In consequence, the air cooled and dehumidified in the heat absorber 9 is further heated in a process of passing the auxiliary heater 23, and hence a temperature rises, thereby performing the dehumidifying and heating of the vehicle interior.

(3) Dehumidifying and Cooling Mode

Next, in the dehumidifying and cooling mode, the solenoid valve 17 is opened and the solenoid valve 21 is closed. Furthermore, the solenoid valve 30 is opened and the solenoid valve 40 is closed. Then, the compressor 2 and the respective blowers 15 and 27 are operated, and the air mix damper 28 has the state of sending, through the auxiliary heater 23 and the radiator 4, all the air in the air flow passage 3 that is blown out from the indoor blower 27 and passed through the heat absorber 9 as shown by a broken line in FIG. 1. Consequently, the high-temperature high-pressure gas refrigerant discharged from the compressor 2 flows through the solenoid valve 30 and flows from the refrigerant pipe 13G into the radiator 4. The air in the air flow passage 3 passes through the radiator 4, and hence the air in the air flow passage 3 is heated by the high-temperature refrigerant in the radiator 4, while the refrigerant in the radiator 4 has the heat taken by the air and is cooled to condense and liquefy.

The refrigerant flowing out from the radiator 4 flows through the refrigerant pipe 13E to reach the outdoor expansion valve 6, and flows through the outdoor expansion valve 6 controlled to slightly open, to flow into the outdoor heat exchanger 7. The refrigerant flowing into the outdoor heat exchanger 7 is cooled by the running therein or the outdoor air passed through the outdoor blower 15, to condense. The refrigerant flowing out from the outdoor heat exchanger 7 flows from the refrigerant pipe 13A through the solenoid valve 17 to successively flow into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and flows through the internal heat exchanger 19 to reach the indoor expansion valve 8. The refrigerant is decompressed in the indoor expansion valve 8 and then flows into the heat absorber 9 to evaporate. The water in the air blown out from the indoor blower 27 coagulates to adhere to the heat absorber 9 by the heat absorbing operation at this time, and hence the air is cooled and dehumidified.

The refrigerant evaporated in the heat absorber 9 flows through the internal heat exchanger 19 and the refrigerant pipe 13C to reach the accumulator 12, and flows therethrough to be sucked into the compressor 2, thereby repeating this circulation. In this dehumidifying and cooling mode, the auxiliary heater 23 is not energized, and hence the air cooled and dehumidified in the heat absorber 9 is reheated in the process of passing the radiator 4 (during the reheating, a radiation capability is lower than that during the heating), thereby performing the dehumidifying and cooling of the vehicle interior.

(4) Cooling Mode

Next, in the cooling mode, the valve position of the outdoor expansion valve 6 is adjusted to a fully opened position in the above state of the dehumidifying and cooling mode. It is to be noted that the air mix damper 28 operates to adjust a ratio at which the air in the air flow passage 3, blown out from the indoor blower 27 and passed through the heat absorber 9, passes through the auxiliary heater 23 and the radiator 4 as shown by a solid line in FIG. 1. Furthermore, the auxiliary heater 23 is not energized.

In consequence, the high-temperature high-pressure gas refrigerant discharged from the compressor 2 flows through the solenoid valve 30 and flows from the refrigerant pipe 13G into the radiator 4, and the refrigerant flowing out from the radiator 4 flows through the refrigerant pipe 13E to reach the outdoor expansion valve 6. At this time, the outdoor expansion valve 6 is fully opened, and hence the refrigerant passes the outdoor expansion valve to flow into the outdoor heat exchanger 7 as it is, in which the refrigerant is cooled by the running therein or the outdoor air passed through the outdoor blower 15, to condense and liquefy. The refrigerant flowing out from the outdoor heat exchanger 7 flows from the refrigerant pipe 13A through the solenoid valve 17 to successively flow into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and flows through the internal heat exchanger 19 to reach the indoor expansion valve 8. The refrigerant is decompressed in the indoor expansion valve 8 and then flows into the heat absorber 9 to evaporate. By the heat absorbing operation at this time, the air blown out from the indoor blower 27 is cooled. Furthermore, the water in the air coagulates to adhere to the heat absorber 9.

The refrigerant evaporated in the heat absorber 9 flows through the internal heat exchanger 19 and the refrigerant pipe 13C to reach the accumulator 12, and flows therethrough to be sucked into the compressor 2, thereby repeating this circulation. The air cooled and dehumidified in the heat absorber 9 is blown out from the outlet 29 to the vehicle interior (a part of the air passes the radiator 4 to perform heat exchange), thereby performing the cooling of the vehicle interior.

(5) MAX Cooling Mode (Maximum Cooling Mode)

Next, in the MAX cooling mode that is the maximum cooling mode, the solenoid valve 17 is opened and the solenoid valve 21 is closed. Furthermore, the solenoid valve 30 is closed, the solenoid valve 40 is opened, and the valve position of the outdoor expansion valve 6 is adjusted to the shutoff position. Then, the compressor 2 and the respective blowers 15 and 27 are operated, and the air mix damper 28 has a state where the air in the air flow passage 3 does not pass through the auxiliary heater 23 and the radiator 4. However, even when the air slightly passes, there are not any problems. Furthermore, the auxiliary heater 23 is not energized.

In consequence, the high-temperature high-pressure gas refrigerant discharged from the compressor 2 to the refrigerant pipe 13G flows into the bypass pipe 35 without flowing toward the radiator 4, and flows through the solenoid valve 40 to reach the refrigerant pipe 13E on the downstream side of the outdoor expansion valve 6. At this time, the outdoor expansion valve 6 is shut off, and hence the refrigerant flows into the outdoor heat exchanger 7. The refrigerant flowing into the outdoor heat exchanger 7 is cooled by running therein or the outdoor air passed through the outdoor blower 15, to condense. The refrigerant flowing out from the outdoor heat exchanger 7 flows from the refrigerant pipe 13A through the solenoid valve 17 successively into the receiver drier portion 14 and the subcooling portion 16. Here, the refrigerant is subcooled.

The refrigerant flowing out from the subcooling portion 16 of the outdoor heat exchanger 7 enters the refrigerant pipe 13B and flows through the internal heat exchanger 19 to reach the indoor expansion valve 8. In the indoor expansion valve 8, the refrigerant is decompressed and then flows into the heat absorber 9 to evaporate. By the heat absorbing operation at this time, the air blown out from the indoor blower 27 is cooled. Furthermore, the water in the air coagulates to adhere to the heat absorber 9, and hence the air in the air flow passage 3 is dehumidified. The refrigerant evaporated in the heat absorber 9 flows through the internal heat exchanger 19 and the refrigerant pipe 13C to reach the accumulator 12, and flows therethrough to be sucked into the compressor 2, thereby repeating the circulation. At this time, the outdoor expansion valve 6 is shut off, so that it is similarly possible to inhibit or prevent the disadvantage that the refrigerant discharged from the compressor 2 flows from the outdoor expansion valve 6 back into the radiator 4. Consequently, it is possible to inhibit or eliminate the decrease of the amount of the refrigerant to be circulated, and it is possible to acquire the air conditioning capability.

Here, in the above-mentioned cooling mode, the high-temperature refrigerant flows through the radiator 4, and hence direct heat conduction from the radiator 4 to the HVAC unit 10 considerably occurs, but the refrigerant does not flow through the radiator 4 in this MAX cooling mode. Therefore, the air from the heat absorber 9 in the air flow passage 3 is not heated by heat transmitted from the radiator 4 to the HVAC unit 10. Consequently, powerful cooling of the vehicle interior is performed, and especially under an environment where an outdoor air temperature is high, the vehicle interior can rapidly be cooled to achieve the comfortable air conditioning of the vehicle interior.

(6) Switching Among Respective Operation Modes of Heating, Dehumidifying and Heating, Dehumidifying and Cooling, Cooling, and MAX Cooling

The air circulated in the air flow passage 3 is subjected to the cooling from the heat absorber 9 and a heating operation (adjusted in the air mix damper 28) from the radiator 4 (and the auxiliary heater 23) in the above respective operation modes, and the air is blown out from the outlet 29 to the vehicle interior. Then, switching among the respective operation modes is performed based on the outdoor air temperature, a temperature of the vehicle interior, a blower voltage, a solar radiation amount, a predetermined temperature of the vehicle interior, and others, and a temperature of the air blown out from the outlet 29 is controlled at a target outlet temperature.

(7) Solenoid Valve

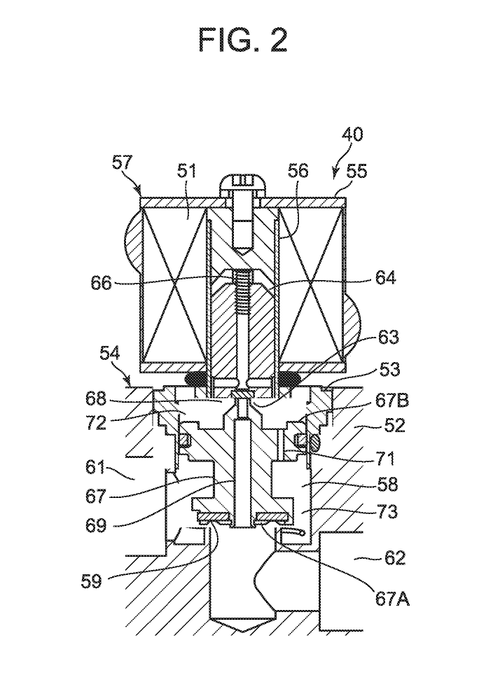

Next, description will be made as to structures and operations of the respective solenoid valves 17, 21, 30 and 40 connected to the refrigerant circuit R of the air conditioning device for the vehicles 1 mentioned above, with reference to FIG. 2 to FIG. 6 and FIG. 11. It is to be noted that the solenoid valve 17 (for the cooling) and the solenoid valve 30 (for the reheating) of the embodiment are normally open solenoid valves energized with an after-mentioned solenoid coil 51 to close their flow paths, and the solenoid valve 21 (for the heating) and the solenoid valve 40 (for the bypass) are normally close solenoid valves energized with the solenoid coil 51 to open their flow paths, but the valves have a similar basic structure. Therefore, the solenoid valve 40 (for the bypass) is described herein as an example.

(7-1) Structure of Solenoid Valve 40

FIG. 2 shows a cross-sectional view of the solenoid valve 40 (for the bypass). It is to be noted that the solenoid valve 40 of the embodiment is a so-called pilot type solenoid valve, and includes a valve body 54 constituted of a valve portion 52 and a mounting base 53 screwed to the valve portion 52, a yoke 55 attached and fixed to the valve portion 52 via the mounting base 53, a guide sleeve 56, and a solenoid 57 constituted of the solenoid coil 51 and others. A valve chamber 58 is formed in the valve portion 52 below the mounting base 53, a valve seat 59 projected in a central portion of the valve chamber 58, an inflow port 61 is formed to open in the valve chamber 58, and an outflow port 62 is formed to open via the valve seat 59.

In the guide sleeve 56 of the solenoid 57, a plunger 64 including a pilot valve body 63 at its lower end (a tip) is slidably inserted and the plunger 64 is usually urged toward the valve seat 59 (downward) by an upper coil spring 66. Furthermore, a main valve body 67 is vertically movably disposed in the valve chamber 58 between the plunger 64 and the valve seat 59, and a pilot chamber 68 is formed between the main valve body 67 and the plunger 64.

The main valve body 67 possesses a cylindrical shape, and a vertically extending pilot orifice 69 is made through a central portion of the main valve body. Through the pilot orifice 69, communication between the pilot chamber 68 and the outflow port 62 is selectively provided or cut off. Furthermore, an equalizing hole 71 is formed in the main valve body 67 to provide the communication between the pilot chamber 68 and the valve chamber 58.

In the main valve body 67 which is lowered, an annular lower end face 67A abuts on the valve seat 59 to cut off communication between the inflow port 61 and the outflow port 62. Furthermore, the main valve body is raised so that an annular upper end face 67B abuts on an annular valve holder 72 formed in a lower surface of the mounting base 53, and in this state, the main valve body 67 provides communication between the inflow port 61 and the outflow port 62. Numeral 73 denotes a lower coil spring inserted in the valve chamber 58 of a lower part of the main valve body 67, and the spring usually urges the main valve body 67 toward the plunger 64 (upward).

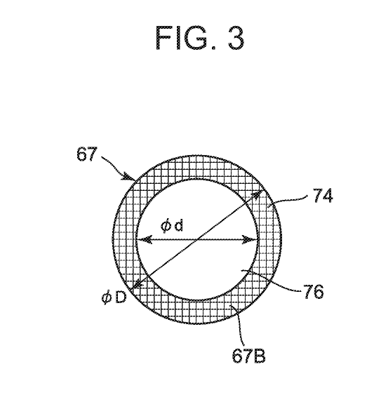

Here, FIG. 3 schematically shows a part (referred to as an abutment surface 74) at which the annular upper end face 67B of the main valve body 67 abuts on the annular valve holder 72 formed on the lower surface of the mounting base 53. In the main valve body 67 of the embodiment, a removed portion 76 is formed in the abutment surface 74 by cutting an inner portion of an abutment surface 74A of a conventional main valve body shown in FIG. 11, and due to the presence of the removed portion 76, an area of the abutment surface 74 (FIG. 3) of the end face 67B of the embodiment is reduced to be smaller than that of the conventional abutment surface 74A (FIG. 11).

That is, when an outer diameter of the abutment surface 74 (74A) is ϕD, an inner diameter thereof is ϕd, an area of a circle having ϕD is SD and an area of a circle having ϕd is Sd, in case of the conventional abutment surface 74A, Sd=SD×0.49, but in the embodiment, Sd=SD×0.81 is satisfied. Furthermore, to obtain an effect of inhibiting adhesion of the main valve body 67 to the valve holder 72 due to oil as described later, it is determined by experiment that Sd>SD×0.7 is required.

(7-2) Operation of Solenoid Valve 40

Next, an operation of the solenoid valve 40 will be described with reference to FIG. 2 and FIG. 4 to FIG. 6. FIG. 2 shows a state where the solenoid coil 51 is non-energized. In this state, the plunger 64 lowers due to its own weight and an urging force from the upper coil spring 66, presses downward the main valve body 67 against the lower coil spring 73, and brings the lower end face 67A into contact with the valve seat 59. Furthermore, in this state, the pilot valve body 63 of the plunger 64 closes an upper end of the pilot orifice 69 of the main valve body 67, and hence communication between the pilot chamber 68 and the outflow port 62 is cut off. This is a closed state of the solenoid valve 40.

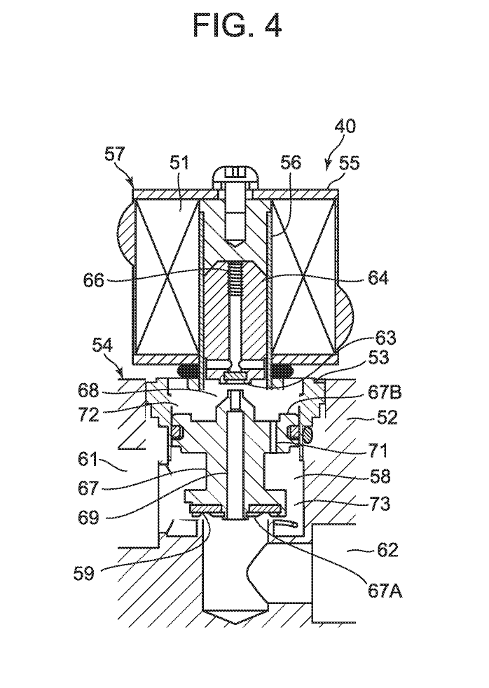

When the solenoid coil 51 is energized in this state, the plunger 64 rises against the upper coil spring 66 due to a magnetomotive force. Consequently, the pilot valve body 63 moves away from the pilot orifice 69 of the main valve body 67 to open the upper end, and hence the pilot chamber 68 communicates with the outflow port 62 (a state of FIG. 4).

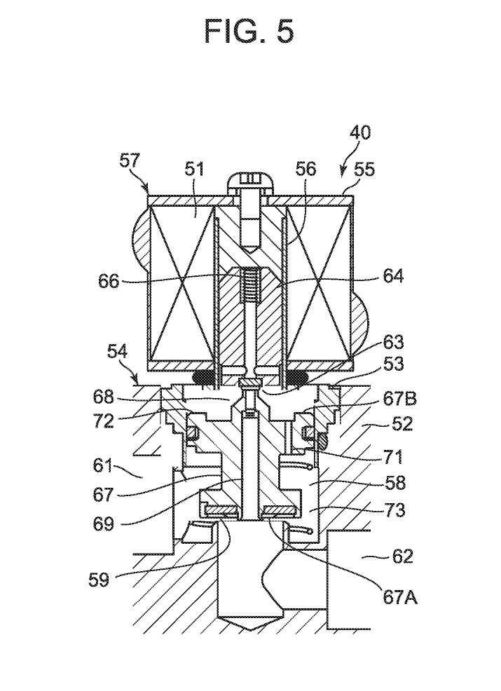

When the pilot orifice 69 opens, the main valve body 67 rises due to a vertical differential pressure of the main valve body 67 (a difference in pressure between the pilot chamber 68 and the valve chamber 58) and an urging force of the lower coil spring 73, the lower end face 67A therefore moves away from the valve seat 59, and the inflow port 61 communicates with the outflow port 62. Consequently, the refrigerant (which contains oil) flows through a route of the inflow port 61, the valve chamber 58 and the outflow port 62. Furthermore, the abutment surface 74 of the upper end face 67B of the main valve body 67 abuts on the valve holder 72 formed on the lower surface of the mounting base 53 (a state of FIG. 5).

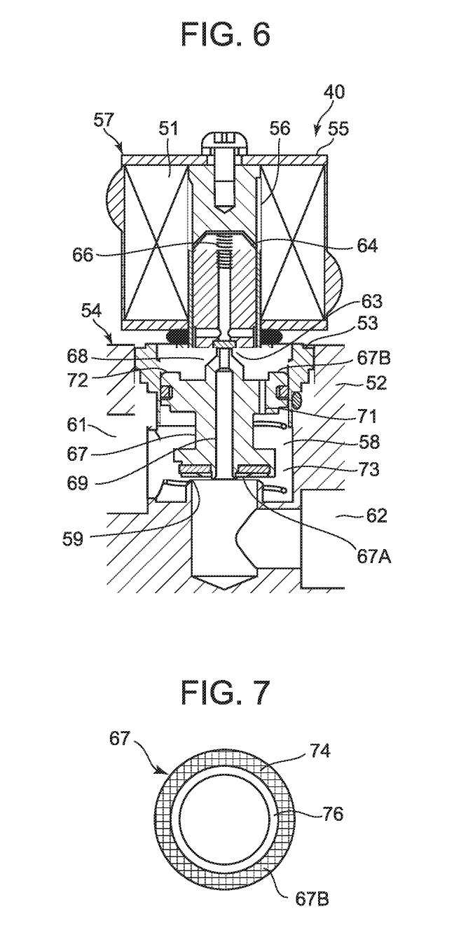

When the solenoid valve 40 is energized with the solenoid coil 51, an open state of FIG. 5 is held. Then, when the solenoid coil 51 is non-energized, the magnetomotive force is eliminated, the plunger 64 therefore lowers due to the urging force of the upper coil spring 66, and the pilot valve body 63 abuts on the main valve body 67 to close the pilot orifice 69 (a state of FIG. 6). Then, the plunger 64 further presses downward the main valve body 67 against the lower coil spring 73, and hence the lower end face 67A of the main valve body 67 eventually abuts on the valve seat 59. Consequently, there is a closed state where the communication between the inflow port 61 and the outflow port 62 is cut off (FIG. 2).

Here, the refrigerant flowing through the valve body 54 of the solenoid valve 40 contains the oil to lubricate the compressor 2. When viscosity of this oil is high and when the abutment surface 74 of the upper end face 67B of the main valve body 67 abuts on the valve holder 72 as shown in FIG. 5 and FIG. 6, there is a risk that the abutment surface 74 adheres to the valve holder 72, the main valve body 67 cannot lower and the solenoid valve 40 cannot close. However, as described above in the present embodiment, the removed portion 76 is formed on the inner side of the abutment surface 74, and the area SD of the circle having the outer diameter ϕD of the end face of the main valve body and the area Sd of the circle having the inner diameter ϕd have a relation of Sd>SD×0.7 (Sd=SD×0.81 in the embodiment). A contact area is reduced as compared with the conventional abutment surface 74A of FIG. 11, and hence it is possible to effectively inhibit or eliminate the adhesion of the main valve body 67 to the valve holder 72 due to oil. It is to be noted that an upper limit of the area Sd is a value Sdmaxlim at which strength of the abutment surface 74A is actually in excess of an allowable limit. That is, Sd may be set to a range larger than 0.7 and smaller than Sdmaxlim (Sdmaxlim>Sd>0.7), and is most ideally set to Sd=SD×0.81 in the embodiment.

Particularly, in the embodiment, the inner side of the upper end face 67B of the main valve body 67 is cut to form the removed portion 76, and hence any hindrance does not occur in vertical movement of the main valve body 67 in the valve chamber 58. In consequence, the main valve body 67 easily moves away from the valve holder 72, an operational defect is hard to be generated, and hence a stabilized operation of the air conditioning device for the vehicles 1 can be acquired.

### Embodiment 2

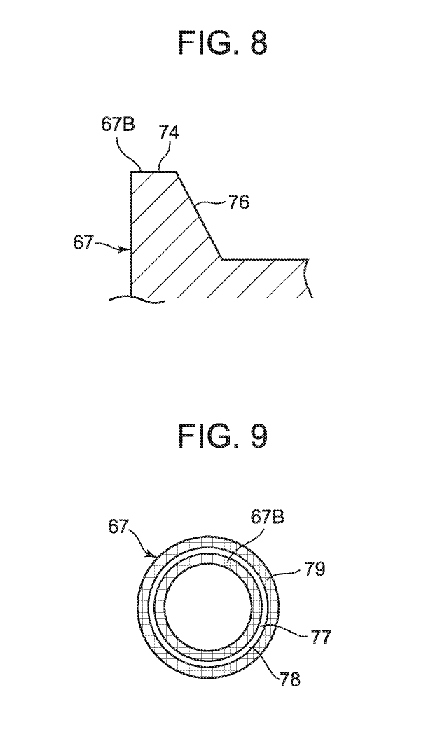

Next, FIG. 7 and FIG. 8 show another embodiment of the abutment surface 74 of the main valve body 67 of the solenoid valve 40. In this case, a removed portion 76 is cut obliquely away from a valve holder 72 toward its inner side (toward a pilot orifice 69 side) (FIG. 8). Consequently, it is possible to maintain strength of an upper end face 67B of the main valve body 67 which abuts on the valve holder 72.

### Embodiment 3

Furthermore, FIG. 9 shows still another embodiment of the upper end face 67B (the end face on a valve holder 72 side) of the main valve body 67 of the solenoid valve 40. In this case, in the annular upper end face 67B of the main valve body 67, an annular groove 77 is recessed and formed by cutting the end face along its arc. When the main valve body 67 rises, the end face 67B of a portion of the groove 77 does not abut on the valve holder 72. Consequently, the groove 77 portion becomes an annular non-abutment portion 78, and abutment portions 79 are formed on inner and outer sides of the groove 77.

Thus, the annular abutment portion 79 and the annular non-abutment portion 78 are formed in the upper end face 67B of the main valve body 67. Also in this case, a contact area between the main valve body 67 and the valve holder 72 reduces, and hence it is possible to effectively inhibit or eliminate adhesion of the main valve body 67 to the valve holder 72 due to oil.

### Embodiment 4

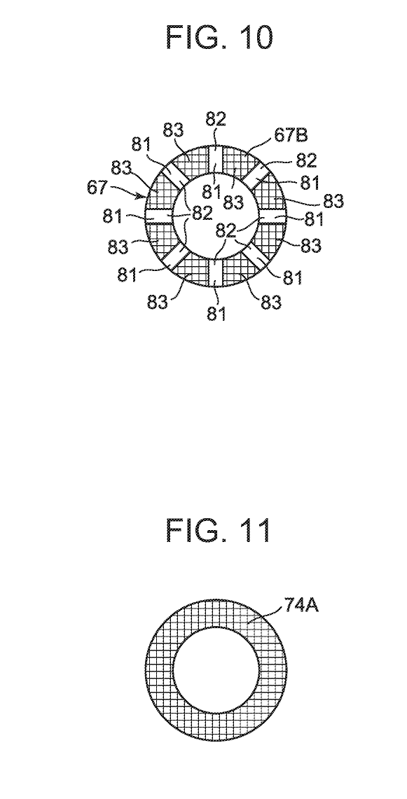

Furthermore, FIG. 10 shows a further embodiment of the upper end face 67B (the end face on a valve holder 72 side) of the main valve body 67 of the solenoid valve 40. In this case, in the annular upper end face 67B of the main valve body 67, a plurality of grooves 81 are recessed and formed radially from the center of an arc of the end face by cutting the end face. When the main valve body 67 rises, portions of the end face 67B which correspond to the grooves 81 do not abut on the valve holder 72. Consequently, the portions of the grooves 81 constitute a plurality of non-abutment portions 82 and an abutment portion 83 is formed between the grooves 81.

Thus, the abutment portions 83 and the non-abutment portions 82 are radially formed in the upper end face 67B of the main valve body 67. Also in this case, a contact area between the main valve body 67 and the valve holder 72 reduces, and hence it is possible to effectively inhibit or eliminate adhesion of the main valve body 67 to the valve holder 72 due to oil.

It is to be noted that in the embodiments, the abutment portions 79 and 83 and the non-abutment portions 78 and 82 are formed in the end face 67B of the main valve body 67 on the valve holder 72 side, but the present invention is not limited thereto, abutment portions and non-abutment portions similar to those of FIG. 9 and FIG. 10 may be formed in the valve holder 72 which abuts on the end face 67B.

Furthermore, the solenoid valve is not limited to the pilot solenoid valve of the embodiment, and the present invention is effective for any solenoid valve including a main valve body which opens or closes a valve seat by energization control to a solenoid coil. Additionally, the present invention has been described in the solenoid valve 40 for the bypass of the embodiment, but the solenoid valve 21 for the heating is also similar thereto. The solenoid valve 17 for the cooling and the solenoid valve 30 for the reheating which are reversely opened and closed also include an abutment portion between the main valve body 67 and the valve holder 72 which has a similar structure. In addition, the solenoid valve of the present invention is used in the air conditioning device for the vehicles 1 in the embodiment, but the inventions other than the invention of claim 8 are not limited thereto, and the present invention is effective for this type of refrigeration device including a refrigerant circuit charged with refrigerant and oil.

### DESCRIPTION OF REFERENCE NUMERALS

1 air conditioning device for the vehicles

2 compressor

3 air flow passage

4 radiator

6 outdoor expansion valve

7 outdoor heat exchanger

8 indoor expansion valve

9 heat absorber

17 solenoid valve (cooling)

21 solenoid valve (heating)

30 solenoid valve (reheating)

40 solenoid valve (bypass)

23 auxiliary heater (an auxiliary heating device)

35 bypass pipe

51 solenoid coil

58 valve chamber

59 valve seat

61 inflow port

62 outflow port

67 main valve body

67B end face

72 valve holder

74 abutment surface

76 removed portion

78 and 82 non-abutment portion

79 and 83 abutment portion

R refrigerant circuit

1. A solenoid valve comprising:
a valve body having a valve chamber, an inflow port, an outflow port, a valve seat and a valve holder,
a main valve body movably disposed in the valve chamber, and
a solenoid coil,
so that controlling of energization to the solenoid coil provides a state where the main valve body is in contact with the valve seat to cut off communication between the inflow port and the outflow port and a state where the main valve body is in contact with the valve holder to provide the communication between the inflow port and the outflow port,
wherein a removed portion formed by cutting an inner side of an end face of the main valve body which is in contact with the valve holder is disposed, and
wherein a relation of Sd>SD×0.7 is satisfied, in which Sd is an area of a circle having an inner diameter ϕd, SD is an area of a circle having an outer diameter ϕD, ϕd is the inner diameter, and ϕD is the outer diameter of the end face of the main valve body.

2. The solenoid valve according to claim 1, wherein the removed portion is cut obliquely away from the valve holder toward its inner side.

3. A solenoid valve comprising:
a valve body having a valve chamber, an inflow port, an outflow port, a valve seat and a valve holder,
a main valve body movably disposed in the valve chamber, and
a solenoid coil,
so that controlling of energization to the solenoid coil provides a state where the main valve body is in contact with the valve seat to cut off communication between the inflow port and the outflow port and a state where the main valve body is in contact with the valve holder to provide the communication between the inflow port and the outflow port,
wherein in an end face of the main valve body on the side of the valve holder, an abutment portion which abuts on the valve holder and a non-abutment portion which does not abut on the valve holder are formed.

4. A solenoid valve comprising:
a valve body having a valve chamber, an inflow port, an outflow port, a valve seat and a valve holder,
a main valve body movably disposed in the valve chamber, and
a solenoid coil,
so that controlling of energization to the solenoid coil provides a state where the main valve body is in contact with the valve seat to cut off communication between the inflow port and the outflow port and a state where the main valve body is in contact with the valve holder to provide the communication between the inflow port and the outflow port,
wherein an abutment portion which abuts on the main valve body and a non-abutment portion which does not abut on the main valve body are formed in the valve holder.

5. The solenoid valve according to claim 3, wherein the valve holder and end face of the main valve body on the valve holder side possess an annular shape, and the non-abutment portion is formed in an annular shape along an arc of the valve holder or the end face of the main valve body.

6. The solenoid valve according to claim 3, wherein the valve holder and end face of the main valve body on the valve holder side possess an annular shape, and the non-abutment portions are formed radially from the center of an arc of the valve holder or the end face of the main valve body.

7. A refrigeration device comprising a refrigerant circuit having the solenoid valve according to claim 1, wherein the refrigerant circuit is charged with refrigerant and oil.

8. An air conditioning device for vehicles comprising:
a compressor to compress a refrigerant,
an air flow passage through which air to be supplied to a vehicle interior flows,
a radiator to let the refrigerant radiate heat, thereby heating the air to be supplied from the air flow passage to the vehicle interior,
a heat absorber to let the refrigerant absorb heat, thereby cooling the air to be supplied from the air flow passage to the vehicle interior,
an outdoor heat exchanger disposed outside the vehicle interior,
an outdoor expansion valve to decompress the refrigerant flowing into the outdoor heat exchanger, and
a plurality of solenoid valves to change flow of the refrigerant,
wherein as these solenoid valves, the solenoid valves according to claim 1 is used, and the solenoid valves are controlled to switch among and execute a plurality of operation modes.
